(19) United States
(12) Patent Application Publication
(10) Pub. No.: US 2022/0083589 A1
(43) Pub. Date: Mar. 17, 2022

(54) INFORMATION PROCESSING APPARATUS, INFORMATION PROCESSING SYSTEM, INFORMATION PROCESSING METHOD, METADATA CREATION METHOD, RECORDING CONTROL METHOD, AND NON-TRANSITORY COMPUTER-READABLE RECORDING MEDIUM RECORDING INFORMATION PROCESSING PROGRAM

(71) Applicant: Olympus Corporation, Tokyo (JP)

(72) Inventors: Toshihiro OGATA, Tokyo (JP); Kazuo KANDA, Tokyo (JP); Toshikazu HAYASHI, Sagamihara-shi (JP); Hideaki YOSHIDA, Tokyo (JP); Kento IGUCHI, Tokyo (JP); Osamu NONAKA, Sagamihara-shi (JP)

(21) Appl. No.: 17/383,380

(22) Filed: Jul. 22, 2021

(30) Foreign Application Priority Data
Sep. 14, 2020 (JP) 2020-153756

(51) Int. Cl. G06F 16/583; G06F 16/58; G06F 21/62; G06F 21/60

(52) U.S. Cl. CPC G06F 16/583; G06F 16/5866; G06F 21/6245; G06F 21/602; G06F 21/6209

(57) ABSTRACT

An information processing apparatus includes a processor. The processor acquires a picked-up image, creates metadata concerning the picked-up image, records an image file including the picked-up image and the metadata, and creates, as the metadata, information concerning the picked-up image with a table format in a first region in the image file and creates the information concerning the picked-up image with unstructured data in a second region extended by the information recorded by the table format in the image file.

### CROSS REFERENCE TO RELATED APPLICATION

This application is based upon and claims the benefit of priority from the prior Japanese Patent Application No. 2020-153756 filed in Japan on Sep. 14, 2020; the entire contents of which are incorporated herein by reference.

### BACKGROUND OF THE INVENTION

### 1. Field of the Invention

The present invention relates to an information processing apparatus, an information processing system, an information processing method, a metadata creation method, a recording control method, and a recording medium recording an information processing program for improving convenience by adding metadata to contents such as an image.

### 2. Description of the Related Art

In recent years, according to progress of an image pickup technique, high-quality image data has been able to be easily acquired. Because of a characteristic excellent in visibility and evidentiality, the image data is not only used for appreciation but also used in various industrial scenes as evidence photographs and monitoring videos. According to spread of IoT (Internet of things), an image pickup function is implemented in various terminals and apparatuses. Image data acquired by these apparatuses is not only used only in a specific facility but also transmitted and received via a network such as the Internet and used in a wide range.

In general, image data is converted into a file when the image data is recorded or transmitted. When the image data is converted into a file, auxiliary data (metadata) other than an image such as information concerning a photographing date and time and a photographing place is sometimes added to the image data. Further, a technique for converting information concerning what is an intention of photographing of the image and what is read from the image into metadata is expected as an important technique in future.

Note that data treated on the Internet is sometimes roughly divided by expressions “structured data” and “unstructured data”. In the “structured data”, “where and what kind of data is presented” is determined. The “structured data” is data (structure) most suitable for retrieval, parsing, and analysis of data. The “unstructured data” is data, each of which alone has its meaning, such as a document, an image, or voice. In embodiments of the present invention, metadata describes data for supplementing an “image”, which is the “unstructured data”. The metadata is also roughly divided and expressed as the “structured data” and the “unstructured data”. Besides, there is also an expression “semi-structured data” obtained by providing delimitation concerning regularity to add a structural element to the “unstructured data” as appropriate. In the following explanation, it is assumed that the “semi-structured data” is also included in the “unstructured data”.

Note that the unstructured data in explaining the metadata is not standardized to make it possible to classify contents in the data but is configured by, for example, text in a free format. Note that the unstructured data also needs to be created according to predetermined syntax information in order to enable computer processing. For interpretation of the contents of the unstructured data, for example, natural language processing is sometimes necessary. In recent years, it has been sometimes possible to acquire useful information with AI by converting the unstructured data into big data. The unstructured data described herein does not include image data itself and is mainly considered to be metadata recorded as data other than structured data. However, as an application, the metadata may include the image data and the unstructured data.

General metadata is often structured data described according to a certain rule (structure) for, so to speak, uniqueness for suppressing fluctuation in interpretation and is excellent in retrievability and conversion into a database by adopting a table format or the like. On the other hand, image data itself is unstructured data not structured. However, in recent years, practical utilization of various image data accessible by the Internet has been expected. According to support of the metadata and use of AI (artificial intelligence), values of the image data as big data such as diversity of data, an abundant data amount, and easiness of real-time generation and collection are considered to increase. Therefore, in addition to the uniqueness, diversity is also requested for the metadata. It is imperative to handle the unstructured data (which may include semi-structured data).

As a retrieval method for such structured data and unstructured data, Japanese Patent Application Laid-Open Publication No. 2013-242915 (Patent Literature 1) proposes a method of extracting unstructured data using structured data. In the proposal of Patent Literature 1, an intelligent and integrated access to the unstructured data is enabled using a database of structured data stored by the database.

However, in the proposal of Japanese Patent Application Laid-Open Publication No. 2013-242915, an access to structured data recorded in a database using a relational database management system and an access to a data store of unstructured data are performed. Individual data not converted into a database cannot be efficiently used.

In view of the above, an object of the present invention is to provide an information processing apparatus, an information processing system, an information processing method, a metadata creation method, a recording control method, and a recording medium recording an information processing program that can makes it possible to secure a degree of freedom while securing uniqueness of metadata, cope with diversification, and facilitate utilization of images.

### SUMMARY OF THE INVENTION

An information processing apparatus according to an aspect of the present invention includes a processor. The processor: acquires a picked-up image; creates metadata concerning the picked-up image; records an image file including the picked-up image and the metadata; and creates, as the metadata, information concerning the picked-up image with a table format in a first region in the image file and creates information concerning the picked-up image with unstructured data in a second region extended by the information recorded by the table format in the image file.

An information processing system according to an aspect of the present invention includes a plurality of information processing apparatuses each including a processor. The processor: acquires a picked-up image; creates metadata concerning the picked-up image; records an image file including the picked-up image and the metadata; and creates, as the metadata, information concerning the picked-up image with a table format in a first region in the image file and creates the information concerning the picked-up image with unstructured data in a second region extended by the information recorded by the table format in the image file, and the processor in a first information processing apparatus among the plurality of information processing apparatuses creates the information concerning the picked-up image with the table format in the first region and the processor in a second information processing apparatus among the plurality of information processing apparatuses creates the information concerning the picked-up image with the unstructured data in the second region.

An information processing system according to another aspect of the present invention includes a plurality of information processing apparatuses each including a processor. The processor: acquires a picked-up image; creates metadata concerning the picked-up image; records an image file including the picked-up image and the metadata; and creates, as the metadata, information concerning the picked-up image with a table format in a first region in the image file and creates the information concerning the picked-up image with unstructured data in a second region extended by the information recorded by the table format in the image file, and the processor in a first information processing apparatus among the plurality of information processing apparatuses creates the information concerning the picked-up image with the table format in the first region and the processor in a second information processing apparatus among the plurality of information processing apparatuses creates the information concerning the picked-up image with the table format in the second region.

An information processing method according to an aspect of the present invention includes: acquiring a picked-up image; creating, as metadata concerning the picked-up image, information concerning the picked-up image with a table format in a first region in an image file and creating the information concerning the picked-up image with unstructured data in a second region extended by the information recorded by the table format in the image file; and recording the image file including the picked-up image and the metadata.

A non-transitory computer-readable recording medium recording an information processing program according to an aspect of the present invention records a program for causing a computer to execute a procedure for: acquiring a picked-up image; creating, as metadata concerning the picked-up image, information concerning the picked-up image with a table format in a first region in an image file and creating the information concerning the picked-up image with unstructured data in a second region extended by the information recorded by the table format in the image file; and recording the image file including the picked-up image and the metadata.

An information processing apparatus according to another aspect of the present invention includes a processor. The processor: acquires a picked-up image; creates metadata concerning the picked-up image; records an image file including the picked-up image and the metadata; and creates, as the metadata and in a first region in the image file, information concerning the picked-up image in a table format by predetermined items as data for each of the items, and creates, in a second region extended by the information recorded by the table format in the image file, the information concerning the picked-up image with semi-structured data, unstructured data, or structured data by items other than the predetermined items.

A metadata creation method according to an aspect of the present invention includes: in order to record first metadata among metadata for an image file including image data in a first region in the image file, creating, as the first metadata, information concerning a picked-up image as structured data, using a predetermined control word; and, in order to record second metadata among the metadata in a second region in the image file designated by information recorded as an item of the structured data, creating, as the second metadata, information concerning a hash value of the first region and the picked-up image as unstructured data.

An information processing method according to another aspect of the present invention includes: acquiring an image; creating, as metadata concerning the image, information concerning the image with a table format in a first region in an image file; when recording the image file including the image and the metadata, recording evaluation information of the image and a hash value of the first region in a second region extended by the information in the table format in the image file; and recording, in a recording region different from the first and second regions, a hash value of data obtained by combining the data of the first and second regions.

A recording control method according to an aspect of the present invention is capable of recording image data and information concerning an evaluation of an image of the image data in association with each other, the recording control method including: performing recording control on a first recording region for recording a plurality of evaluation entities that evaluate the image and data in a table format indicating presence or absence of an evaluation result of each of the plurality of evaluation entities; and performing recording control on a second recording region for recording, as unstructured data, detailed information of the plurality of evaluation entities and the evaluation result of each of the plurality of evaluation entities.

A recording control method according to another aspect of the present invention is capable of recording image data and information concerning an evaluation of an image of the image data in association with each other, the recording control method including: performing recording control on a first recording region for recording a plurality of evaluations obtained by evaluating the image and data in a table format indicating schematic information such as presence or absence of an evaluation result about the respective evaluations; and performing recording control on a second recording region for recording, as unstructured data, detailed information of the plurality of evaluations.

### BRIEF DESCRIPTION OF THE DRAWINGS

FIG. 1 is a block diagram showing an information processing apparatus according to a first embodiment of the present invention;

FIG. 2 is an explanatory diagram showing a data structure of extended metadata;

FIG. 3 is a flowchart for explaining operation in the first embodiment;

FIG. 4 is a block diagram showing a second embodiment of the present invention;

FIG. 5 is a flowchart showing an operation flow adopted in the second embodiment;

FIG. 6 is an explanatory diagram showing an example of a method of use assumed in the second embodiment; and

FIG. 7 is an explanatory diagram showing extended metadata generated in the second embodiment.

### DETAILED DESCRIPTION OF PREFERRED EMBODIMENTS

Embodiments of the present invention are explained in detail below with reference to the drawings.

### First Embodiment

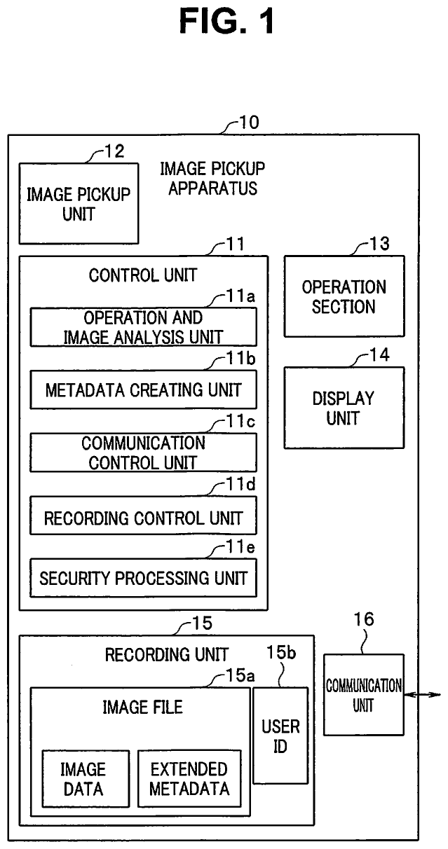

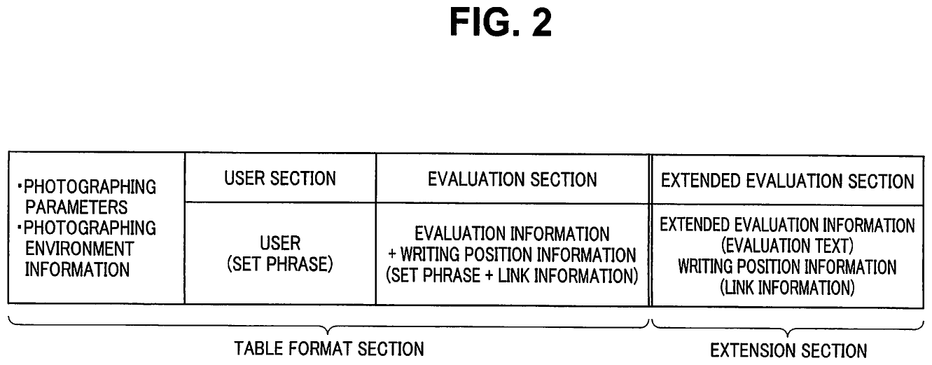

FIG. 1 is a block diagram showing an information processing apparatus according to a first embodiment of the present invention. FIG. 2 is an explanatory diagram showing a data structure of extended metadata.

The present embodiment obtains an image file having high retrievability and excellent extendability and analyzability by adopting a data structure in which metadata is extended, not only a table format section including a structured data portion but also an extension section including an unstructured data portion is provided, and link information for enabling an access to the extension section is described in the table format section.

A second region extended by information recorded by the table format in the image file corresponds to a method of use of various images in future. Therefore, it is important that relatively free description is possible in the second region. “Extended by recorded information” means that information of an extended region is interpreted in a context based on the recorded information and means that the recorded information is a transfer item and supplementary information is added to the extended region according to a transferred instruction and may be referred to rather than meaning that an address can be simply designated or a referable contrivance is performed. This is possible even if an address of the second region is fixed. The table format can be described by “quality” information, information instructing to refer to the extended region, or the like and, in an extreme example, a control word (which may be a signal such as a flag) indicating 1 or 0. Free description can be performed in the extension section. Therefore, if information “a reason for quality described in the table format” is supplemented, it is possible to interpret that the information is detailed information of the transferred item. The description “extended by information recorded in a table format” may be interpreted as “having content specified by information recorded using a control word” or “having content derived by information recorded using a control word”.

### (Structured Data)

In the present embodiment, structured data is data format standardized to be capable of classifying contents to make it possible to recognize types of contents in data including meanings and backgrounds. The data is stored according to a specified structure for managing the data. Therefore, the structured data is excellent in retrievability, is wide in a utilization range by standardization, has uniqueness of interpretation, and is easy to be maintained and treated. The structured data is created according to, for example, a specific syntax.

### (Unstructured Data)

In the present embodiment, unstructured data is data other than the structured data. The unstructured data is not standardized to be capable of classifying contents in data and is configured by, for example, a free-format text. Note that the unstructured data also needs to be created according to predetermined syntax information to enable computer processing. For example, natural language processing is sometimes necessary for interpretation of contents of the unstructured data. In recent years, useful information has been able to be acquired by AI by converting unstructured data into big data. Note that, in the following explanation, it is assumed that data classified as “semi-structured data” or the like obtained by providing delimitation concerning regularity to add a structural element to the “unstructured data” as appropriate is also included in the “unstructured data”.

First, a data structure of extended metadata in the present embodiment (hereinafter also referred to as extended metadata) is explained with reference to FIG. 2.

An image file in the present embodiment includes the image data and the extended metadata. The extended metadata in the present embodiment includes a table format section and an extension section as shown in FIG. 2. Note that information of the table format section and information of the extension section are respectively referred to as table format information and extended information.

### (Table Format Section)

The table format section is described in a table format and is configured by structured data in which items (tags) to be described are specified in advance. Note that when a syntax is specified in advance and, for example, positions of items in a file are determined, the table format section is sometimes configured by data of, for example, a CSV (comma separated value) format in which description is unnecessary about item names themselves. In the present embodiment, the table format section includes the data of the CSV format or the like. The table format section may be referred to as basic section as opposed to the extension section. Alternatively, in use, it is assumed that control words controlled by a specific rule in advance are used as the item names and entities of values of the item names and data and content corresponding to the item names are also control words. The control words can preferably be represented by simple alphanumerical signs or the like.

The table format section may be described by a binary format or a tag format such that, for example, high-speed processing is possible in a photographing device. For example, the table format section may be configured by Exif (exchangeable image file format) data. The Exif data is data obtained by describing tag contents in a binary or text format and arranging the tag contents respectively for a plurality of tag numbers (described in the binary format).

Note that the binary format is representation of data in arrangement of limited bits of 0 and 1 and can be simple text information such as words and numerical values according to a specific rule but is data of a specific format different from a free description text. Numerical values, determined texts, or the like can also be described in the table format section. Note that the text format includes control codes and syntax information for display control with respect to character codes for characters of a natural language, which a person can read and understand, and indicates data of a format suitable for easy reading and writing by a human.

In the table format section, like the general Exif data, various kinds of information concerning photographing such as shutter speed, photographing time, aperture, and a focus position may be described. Further, in the present embodiment, information concerning photographing parameters, information concerning photographing environment information, and the like can be described in the table format section. In FIG. 2, an example is shown in which a user section for specifying a user who performs an evaluation and an evaluation section indicating content of the evaluation by the user are described as the information. When the table format section is represented as a first region, the first region may be referred to as metadata region where information concerning a picked-up image is created as data of respective items in a table format for predetermined items. Note that the information that can be described in the table format section is not limited to the user section and the evaluation section.

In the user section, a set phrase, a constraint word, or a control word (a text registered in advance) for specifying a user is described. For example, a set phrase such as “cameraman” or “assistant” may be described. Note that, about a user registered in an information processing apparatus explained below, a registered user name or an identification number (ID) of the user can be described as a set phrase. In fact, it is hard to cope with a description such as “who and where” deviating from the set phase. However, simple alphabet notation is possible for a country name corresponding to “where”. The alphabet notation can be described in the table format section as a control word. A control word standardized in advance and having no fluctuation in interpretation may be described in the extension section explained below according to necessity.

In the evaluation section, a predetermined set phrase or constraint word such as “excellent image” or “focused image” or a mark, a sign, or the like corresponding to the set phrase or the constraint word can be described. Since the data of the tag format, the constraint word, or the like is used in the user section and the evaluation section, the table format section is excellent in retrievability. In other words, since the table format section has characteristics of structured data, the table format section is excellent in retrievability. The table format section is described according to specified syntax information. A device capable of processing the syntax information can relatively easily recognize content of the table format section. However, it is difficult to cope with a detailed description such as “where and how an image is excellent” deviating from the set phrase. Therefore, when utilization of a new image is conceived based on various scenes of use, the information of the first region is sometimes insufficient. A second region (an extended region or an extension section) supplementing the information of the first region is provided according to necessity.

Further, in the present embodiment, in the evaluation section, link information, which is writing position information for enabling an access to the extension section, can be described. The link information indicates a position on an image file or a position on a memory. Note that the link information is also described according to specified syntax information. The link information may be a pointer capable of specifying a position on the memory of the extension section. The link information may be information concerning a numerical value or a name for specifying the position of the extension section. In this case, a camera, another dedicated device, or the like, performance of a CPU of which is relatively low, sometimes can easily designate the link information.

The table format section is considered, so to speak, a format for describing control words in control word items. Therefore, it is easy to standardize the table format section and perform interpretation without fluctuation across industries. When a workflow of AI is considered, as an image, there are two possibilities of an image as teacher data for learning and an input image for inference. Distinction information for, for example, distinguishing whether the image is for learning or for inference is easily treated by a control word. Since the table format section is a portion without a difference in idea across industries, information for identification such as an identification sign may be incorporated in the table format section. Naturally, there is also a method of confirming whether the image is for learning or for inference referring to the extension section. Whether data is teacher data or test data or reliability or the like at an inference time is relatively easily described in the table format. Therefore, the description may be recorded in the first region.

### (Extension Section)

In the extension section, extended information relating to the image data and the table format information is described. The extension section is configured by unstructured data and has extremely high extendability and degree of freedom. In FIG. 2, an example is shown in which an extended evaluation section is described in the extension section to correspond to the evaluation section of the table format section. However, information that can be described in the extension section is not limited to this.

In the present embodiment, the extension section does not need to be described according to predetermined specified syntax information. Accordingly, it is necessary to perform a syntax analysis corresponding to the extension section in order to interpret content of the extension section. For example, the information processing apparatus may retain syntax information corresponding to the extension section, interpret the content of the extension section using the syntax information, or read out the syntax information corresponding to the extension section from an external device and interpret the content of the extension section using the read-out syntax information. Extended information including the syntax information may be described in the extension section. In this case, the information processing apparatus reads out the syntax information from the extension section and interprets the content of the extension section using the read-out syntax information. However, since various expressions having the same meaning are sometimes present and puzzling, a control word standardized and without fluctuation in interpretation can be described in the extension section in advance according to necessity. The control word is likely to be accepted in specific industries and companies. The “standardization” may be performed in such a range.

In the present embodiment, the extension section is capable of specifying a position in a file or a recording position of a recording medium according to link information. Only one extension section is shown in FIG. 2. However, the image file in the present embodiment may include a plurality of extension sections. In this case, a plurality of kinds of link information for accessing the plurality of extension sections may be described in the evaluation section of the table format section. Link information for accessing a next extension section may be described in the extension section. Even if the link information is absent, extension section description described in a specific address and table format description only have to be able to be associated with each other in meaning.

When such a portion (the first region) of the structured form is set as a main portion and a portion not fully structured is set as the extended region (the extension section or the second region), even if it is difficult to incorporate complicated information in the structured portion, it is possible to describe, in the structured portion (in the first region), whether information to be supplementarily explained in the extension section is present. Further, it is also possible to describe basic information indicating, for example, what kind of an image the image is or what kind of inference is obtained using the image as original information. In the first region, information concerning indication, a summary, positioning of content written in the second region and the like can be taken note of according to a structured rule. For example, the information can also be used as transfer information. The transfer information can be used in two ways. First, when the transfer information is present but corresponding information is absent in the second region, this means that the information of the second region is a requested image. When the transfer information is present and the corresponding information is present in the second region, as a basic method of interpretation of the information of the second region, the information has to be interpreted by a logic modifying the transfer information. Even if “a color of this image” is written as the information of the second region, it is sometimes unknown whether “a color of the image” is good or bad. However, since such information about good or bad is easily structured, the information only has to be described in the first region. In other words, there is no fluctuation in interpretation of positioning of a basic message or the like about description in the extended region. It is possible to determine whether it is necessary to further read and interpret the extended region such as the structured transfer information. It goes without saying that, by making it possible to, for each of structured items, describe information of the second region corresponding to the item, an additional writing, detailed interpretation, and the like can be respectively described in different second regions for each of items in the first region. The two regions can be properly used to describe, in a table format, coordinate information or the like in a screen because the coordinate information is easily described as a numerical value and supplementary information or the like at a time of detecting what is present there or detecting an object present there is described in the extension section. Since the extension section has a degree of freedom of extension, results of an image evaluation may be able to be additionally written in the extension section one after another. For example, there is use for describing an overview of a first evaluation in a table format and writing a reason for the description in the extension section. When a second opinion and a third opinion are present, it is possible to sequentially additionally write the second opinion and the third opinion while including, for example, information about delimitation in the description. Presence or absence of such information may be described in the table format section. “Second opinion follows” may be additionally written in the extension section.

Such a relation between the first region and the second region can be effectively used in terms of security. Therefore, the relation is explained below.

As explained above, in the image file adopted in the present embodiment, the table format section excellent in retrievability and the extension section excellent in extendability are provided in the extended metadata. Therefore, it is possible to adopt a method of use for, for example, selecting desired information from information in a wide range and acquiring detailed content about the selected information. For example, it is also possible to acquire primary information using the table format information and acquire secondary information using the extended information.

In the second (recording) region for recording the extended metadata, since an extended function and a degree of freedom of the second (recording) region are important, information concerning an image obtained by image pickup may be recorded by the unstructured data including the semi-structured data explained above. Alternatively, the information may be created by structured data having independent specifications by items other than determined items recorded in the first region, for example, other than predetermined items.

This assumes information serving as grounds of an evaluation and information that should be referred to such as graphs, tables, and drawings (images). Since the extension section can treat unstructured data, this image can be utilized according to a local rule. In consideration of a workflow of AI, important information in an image used as teacher data is an ID of an inference model, such as an ID indicating the teacher data is for creating what kind of inference model, or an ID indicating what kind of inference model the image data to be inputted to the inference model assumes. However, since an uncountable number of such inference models exist, it is difficult to designate an inference model using a control word. Therefore, if the information is described in the extension section to make it possible to refer to specifications and the like of the information through the Internet or the like, a system configuration is simplified and easily designed. It is difficult to convert annotation information of an image serving as teacher data and inference result output information into control words. Therefore, it is more convenient to treat the information in the semi-structured data of the extension section.

### (Security)

It is conceivable that the table format section is created by, for example, a photographing device or a peripheral device of the photographing device. On the other hand, it is also conceivable that the extension section is created not only during photographing but also after the photographing. In this case, it is sometimes desirable to take security measures such as tampering prevention for information acquired by the photographing device from a viewpoint of, for example, securing evidence. Therefore, in the present embodiment, the table format section may be hashed by applying hash operation (state operation) to the entire table format section. The extension section may also be hashed.

Not only the extended metadata portion but also the image data may be hashed. Further, the image data may be not only hashed but also subjected to predetermined encoding processing. For example, encryption processing such as electronic signature may be applied to the image data.

Since the image data appeals to visual senses when being displayed, it is likely that the image data is enlarged or reduced to be clearly seen, viewed again by changing visibility such as brightness, contrast, or gradation, or intuitively operated with importance placed on sensuous appearance by trimming, foreign matter removal, or the like. If a result of such operation is recorded by mistake, confusion with an original image undesirably occurs. Therefore, first, it is preferable to clearly show a history of presence or absence of such processing. Means for copying and downloading the image data to prevent confusion with the original is also necessary. Data representing the original and the copy may be able to be recorded as metadata. If processing for hashing the image data including the metadata is performed, it is possible to prevent such confusion.

The hashing is a method of calculating, from original data, a fixed-length value without regularity called hash value according to a fixed calculation procedure and representing the original data with the value (conversion into a hash value). In other words, since there is a principle that, if the original data is altered, the hash value changes, it is possible to find tampering, an unconscious change, or the like by checking whether a recorded hash value and a present hash value are the same. When, for example, the evaluation for writing in the second region while viewing the data (for example, the photographed image) or the like in the first region is performed as explained above, reliability of the evaluation changes if data, based on which writing in the second region is performed, is altered. Therefore, if the first region is hashed, an evaluation of the second region can also be considered doubtful if the data is altered. In other words, it is preferable that a first region hash value before writing of content described in the second region is recorded. If the first region hash value is recorded in the second region, it can be confirmed that there is no contradiction between described content of the second region and content of the first region. Reliability of the data is improved.

Naturally, a method of recording the first region hash value in another recording region to make it possible to refer to the first region hash value may be adopted. An evaluation result of the second region is sometimes additionally written in the first region. In that case, data in a region other than a recording region for additional writing only has to be converted into a hash value. Since the hash value is important, there is also a method of hashing the data including the hash value. There is also a method of encrypting and recording the hash value.

As explained above, the information processing apparatus (method) creates metadata concerning an acquired image and records an image file including the picked-up image and the metadata. During the metadata creation, the information processing apparatus (method) creates, as the metadata, information concerning the picked-up image with a table format in the first region in the image file. The information processing apparatus (method) records, in the second region extended to be accessible by the information recorded by the table format in the image file, a hash value and image evaluation information of the first region and further records, in another recording unit, a second hash value obtained by combining the data of the first and second regions. Therefore, simply by confirming the second hash value, it is possible to simultaneously confirm whether the image is tampered with and whether a correspondence relation between the image and the evaluation is tampered with. Since the information for accessing the extended region is included in the table format section, it is possible to immediately access the extended region. Even if the second hash value is recorded in the table format section, it is possible to immediately verify a data history using the second hash value. Note that, in this case, a recording region of the table format section for recording the second hash value is excluded from hashing candidates not to be determined as being tampered with. The second hash value may be recorded in an easily accessible portion in a recording region other than the table format section.

Further, in the present embodiment, for example, when a plurality of extension sections are provided, the table format section and an extension section directly related to the table format section may be hashed as a package. In this case, every time the extension section is extended, a package hashed to that point and the extended extension section may be packaged and hashed. The data in the first region and the data in the second region may be combined and hashed. Further, hash values of the data in the first region may be combined to form a hash. If the hash value does not change from the same hash value after a specific step or elapse of time, it is seen that there is no alteration. Consequently, such hashing allows to record that a result of the first region is approved and that the approved result is not altered.

Every time the extension section is extended, the extension sections are packaged in order and hashed. Consequently, there is an advantage that it is possible to secure evidence and individually detect evaluations. If a history and the like of hash values of the extension sections are recorded, it is possible to, for example, track at which point in time a problem occurred. For means for tampering prevention, strictness for controlling malicious processing is requested. On the other hand, readiness for easily finding processing due to a good will or a fault of unconsciously performing unnecessary operation is also requested. A system for, for example, encryption and management of a hash value only has to be examined in balance of the strictness and the readiness.

With such means, authenticity is guaranteed about a verification target and approval, writing in the second region, and the like also have authenticity. Even if a problem of mismatch of hash values occur, since each of respective kinds of work is hashed, it is possible to verify later in which work a trouble causing the mismatch occurred and trace back the trouble.

Even when a hash value of the second region is incorrect, if a hash value of the first region is correct, work only has to be performed again from the first region. When an image or accompanying information at that time is corrected or changed, since an entire hash value to the second region also changes, the correction or the change is immediately found when reviewed. In other words, a hash value to the first region is considered to not change if the hash value to the second region does not change. Therefore, time for confirmation can be reduced.

When malicious processing is performed, there is also a trick of tampering with a hash value as well. Therefore, there are a variety of methods of securing security such as encryption of the hash value. However, only such illustration is described here. In the following explanation, an expression “state operation is performed” is used instead of hashing.

As explained above, FIG. 2 shows a configuration of an improved idea of the metadata included in the image file. Metadata obtained by collecting photographing date and times, photographing parameters, photographing environments, and the like in a table format has been proposed by business groups and the like. This format has an advantage that only a portion desired to be viewed can be easily checked only if an arrangement about where and what is written is standardized. In other words, since interpretation is unique and easy, the metadata is extremely easy to use for the same purpose and has been widely spread. Simple numbers, signs, and the like can be included in the metadata. This is because, since the numbers, the signs, and the like do not require a special syntax analysis (parsing), the numbers, the signs, and the like can be easily read from a table and can be easily interpreted from items of the table. Creation and reading of the metadata can also be performed by a simple system. However, since the table format section does not have a degree of freedom, the table format section is not suitable for a use in which various people add notes to images. Means for enabling some text to be freely described is necessary. For example, when metadata is added to a medical image, there are a lot of matters that should be described such as a patient, a lesioned part, and a case. It is also important who describes the matters. However, it is difficult to set a simple rule. Rather, mean for forming a free-description text and making it possible to interpret the text is considered to be preferable. The extension section satisfies such a request. However, some mechanism for a syntax analysis such as a language or a grammar is necessary for this (text use). Therefore, unlike the table format section, relatively advanced hardware or program is necessary for writing and reading. Therefore, devices that this text section can treat are relatively limited. With such means, when an ID of a system in which an image is treated, address information of a recording place to be recorded and retrieved, an inference model ID based on which an image is analyzed, and an ID of an inference engine in an analysis performed using an inference model only have to be recorded. URL (uniform resource locator) information or the like for acquiring information not fully written here via a network such as the Internet can also be described. Although such measures can be taken, in order to effectively utilize this information, a system, a circuit, a program, and the like connected to the Internet or the like are necessary. This deviates from specifications usable in all apparatuses. Therefore, such information is recorded in the second (recording) region. Only the first region can be independently used by a simple apparatus.

### (Configuration)

Subsequently, a specific application example is explained with reference to FIG. 1. FIG. 1 shows an example in which an information processing apparatus is configured by an image pickup apparatus 10.

In FIG. 1, the image pickup apparatus 10 includes a control unit 11 that controls the entire apparatus. The control unit 11 may be configured by a processor using a CPU (central processing unit) or an FPGA (field programmable gate array). The control unit 11 may operate according to a program stored in a not-shown memory to control respective units or may realize a part or all of functions with a hardware electronic circuit.

The image pickup apparatus 10 includes an image pickup unit 12 configured by an image pickup device such as a CCD or CMOS sensor. The image pickup unit 12 is configured by a not-shown lens that captures an object optical image of the image pickup apparatus 10 and a not-shown image pickup device that photoelectrically converts an object image from the lens and obtains a picked-up image signal.

The image pickup unit 12 is controlled to be driven by the control unit 11 and photographs an object via the lens and outputs a picked-up image. The control unit 11 outputs a driving signal for driving the image pickup device to the image pickup unit 12 and reads out the picked-up image outputted from the image pickup unit 12. The control unit 11 performs predetermined signal processing, for example, color adjustment processing, matrix conversion processing, noise removal processing, and other various kinds of signal processing on the read-out picked-up image.

An operation section 13 is provided in the image pickup apparatus 10. The operation section 13 is configured by a release button, function buttons, various switches and the like for photographing mode setting and the like, a microphone for capturing voice of a user, and the like provided in the image pickup apparatus 10, which are not shown in FIG. 2 and configured to generate an operation signal based on user operation and output the operation signal to the control unit 11.

A display unit 14 is provided in the image pickup apparatus 10. The control unit 11 executes various kinds of processing concerning display. The control unit 11 can give the picked-up image after the signal processing to the display unit 14. The display unit 14 includes a display screen such as an LCD (a liquid crystal display panel) and displays the image given from the control unit 11. The control unit 11 is configured to be able to cause the display unit 14 to display various menu displays and the like on the display screen of the display unit 14.

Note that a not-shown touch panel configuring the operation section 13 may be provided in the display unit 14. The user can generate an operation signal corresponding to a pointed position on the display screen by touching the touch panel.

Note that the display unit 14 may be disposed to occupy, for example, a substantially entire region of a rear surface of the image pickup apparatus 10. A photographer can check a through-image displayed on the display screen of the display unit 14 in photographing and can perform photographing operation or the like while checking the through-image.

A recording control unit 11d is provided in the control unit 11. The recording control unit 11d can compress the picked-up image after the signal processing and give an image after the compression to a recording unit 15 and cause the recording unit 15 to record the image. As the recording unit 15, for example, a card interface can be adopted. The recording unit 15 is configured to be able to record image information, voice information, and the like in a recording medium such as a memory card and read out and reproduce the image and voice information recorded in the recording medium.

The recording unit 15 includes an image file recording region 15a for recording an image file and a region 15b for recording information concerning a user ID. In the region 15a, an image data recording region for recording image data and an extended metadata recording region for recording extended metadata are provided.

A communication unit 16 is provided in the image pickup apparatus 10. A communication control unit 11c is provided in the control unit 11. The communication unit 16 is controlled by the communication control unit 11c to be able to perform communication with a not-shown external device and transmit and receive information. Note that, as the communication unit 16, various transmission lines can be adopted. For example, a wired transmission line adopting a wired cable such as a LAN and a wireless transmission line adopting a wireless LAN, Bluetooth (registered trademark), WiMAX, a telephone line network, or the like can be used.

In the present embodiment, the control unit 11 includes a metadata creating unit 11b. The metadata creating unit 11b creates extended metadata in photographing of a picked-up image from the image pickup unit 12. For example, the metadata creating unit 11b may be configured to create the table format section in the extended metadata shown in FIG. 2 during the photographing of the picked-up image and create the extension section in the extended metadata shown in FIG. 2 after the photographing.

Note that creation timing for the table format section and the extension section by the metadata creating unit 11b is not limited to this. For example, the metadata creating unit 11b may be configured to create only metadata other than the user section and the evaluation section shown in FIG. 2 in the table format section during the photographing of the picked-up image and create the table format section and the extension section of the extended metadata shown in FIG. 2 after the photographing. Further, the metadata creating unit 11b may be configured to create the table format section and the extension section at different timings after the photographing.

The control unit 11 includes an operation and image analysis unit 11a. The operation and image analysis unit 11a analyzes user operation and control of the image pickup unit 12 based on the user operation and performs an image analysis of a picked-up image and acquires information concerning extended metadata. The metadata creating unit 11b creates the extended metadata based on the information acquired by the operation and image analysis unit 11a.

For example, the operation and image analysis unit 11a can acquire photographing parameters such as shutter speed, photographing time, aperture, and a focus position. The metadata creating unit 11b can describe various photographing parameters in the table format section. The operation and image analysis unit 11a can acquire information concerning various photographing conditions including a peripheral environment. The metadata creating unit 11b can describe, for example, information concerning photographing conditions as well in the table format section. The operation and image analysis unit 11a acquires information concerning the user ID of the photographer from the information recorded in the region 15b. Consequently, the metadata creating unit 11b can create information of the user section of the table format section.

Further, in the present embodiment, the operation and image analysis unit 11a acquires, based on user operation or based on an image analysis result, for example, information indicating a result of an evaluation for an image. For example, when the photographer performs input (including voice input) operation for information indicating an evaluation of, for example, superiority and inferiority of a picked-up image, the operation and image analysis unit 11a acquires information concerning the evaluation. For example, when an evaluation of, for example, superiority and inferiority of a focus can be determined by an image analysis for the picked-up image, the operation and image analysis unit 11a acquires information concerning the evaluation. The metadata creating unit 11b can generate information of the evaluation section based on the information acquired by the operation and image analysis unit 11a.

Further, in the present embodiment, the operation and image analysis unit 11a is also capable of acquiring, based on user operation, information concerning a reevaluation by the user for the picked-up image. For example, the user can operate the operation section 13 such as the touch panel and input the reevaluation for the picked-up image in a text format. Note that the operation and image analysis unit 11a can also acquire, through voice recognition processing for voice of the user acquired by a microphone, evaluation information based on the voice of the user. The metadata creating unit 11b describes the information concerning the reevaluation in the extended evaluation section.

Note that, when creating the extended evaluation section, the metadata creating unit 11b describes, in the evaluation section, link information for accessing extended information to be created. For example, irrespective of presence or absence of creation of the extended evaluation section, the metadata creating unit 11b may describe, as the link information, a pointer of an extended evaluation section to be created next. When creating two or more extended evaluation sections, irrespective of presence or absence of creation of a next extended evaluation section, the metadata creating unit 11b may describe, as the link information, in an immediately preceding extended evaluation section, a pointer of an extended evaluation section to be created next.

Note that, in FIG. 2, an entity of the evaluation and the reevaluation of the evaluation section and the extended evaluation section is explained as being the user who performs the photographing. However, one or a plurality of users other than the user who performs the photographing are also capable of performing the evaluation, the reevaluation, and the like. In this case, the metadata creating unit 11b may be configured to describe, in the evaluation section and the extended evaluation section, information concerning users who are entities of the evaluation and the reevaluation.

Conversely, the metadata creating unit 11b may be configured to be unable to describe information concerning the evaluation, the reevaluation, and the like when users who are entities of the evaluation and the reevaluation are different in the evaluation section and the reevaluation section.

The metadata creating unit 11b gives the created extended metadata to the recording unit 15 and records the created extended metadata. In other words, the metadata creating unit 11b records the image data of the picked-up image in the image data recording region of the region 15a and records the extended metadata in the extended metadata recording region of the region 15a. Note that the metadata creating unit 11b is configured to update the information of the extended metadata in the region 15a every time the evaluation section or the extended evaluation section of the extended metadata is created anew.

A security processing unit 11e is provided in the control unit 11. The security processing unit 11e applies predetermined security processing to the metadata created by the metadata creating unit 11b. For example, at a stage when the table format section in the image data and the extended metadata is recorded in the region 15a of the recording unit 15, the security processing unit 11e may package these data and perform hash operation (state operation) to hash the data. Further, at a stage when the extended metadata in the region 15a is updated and the extended evaluation section is recorded, the security processing unit 11e may package and hash the image data and the table format section, which are packaged, and the extended metadata. Further, at a stage when the extended metadata in the region 15a is updated and the extended evaluation section is additionally recorded, the security processing unit 11e may package and hash a package portion hashed last time and the additionally recorded extended evaluation section.

Note that, as explained above, the image pickup apparatus 10 is configured by the image pickup unit 12, the control unit 11 that controls a function (a circuit or a program) for processing an image signal obtained by the image pickup unit 12 and a function (a circuit or a program) for adjusting exposure, a focus, and the like during image pickup, the recording unit 15 that records a picked-up image, and the like. However, these units only have to operate in cooperation and do not always need to be an integrated structure.

The operation section 13 that receives operation of the user and the display unit 14 for checking a photographed image may also be integrated. However, since apparatuses capable of remotely performing operation and check in a wired or wireless manner are increasing, the operation section 13 and the display unit 14 may be separate. The control unit 11 has a function of creating the extended metadata and includes the recording control unit 11d that records the extended metadata and the image data in the recording unit 15 as the image file and the communication control unit 11c that controls the communication unit 16 for transmitting the created and recorded image file to the outside. This communication control may obtain a function of disclosing content of the recording unit 15 to the outside.

### (Action)

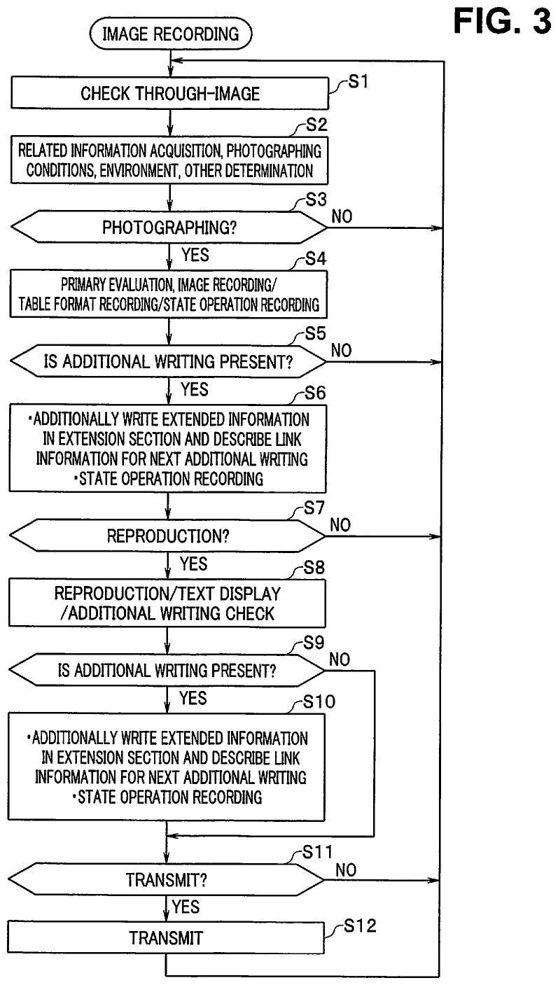

Subsequently, operation in the embodiment configured as explained above is explained with reference to FIG. 3. FIG. 3 is a flowchart for explaining operation in the first embodiment. FIG. 3 shows creation and recording control for an image file by the control unit 11.

In step S1 in FIG. 3, the control unit 11 captures a picked-up image from the image pickup unit 12 and, after applying predetermined image processing to the picked-up image, displays the picked-up image on the display unit 14 as a through-image. The photographer performs photographing operation while checking the through-image.

In step S2, the operation and image analysis unit 11a performs various determinations of information concerning photographing (related information), photographing conditions, a photographing environment, and the like. For example, the operation and image analysis unit 11a obtains information concerning the photographer, information concerning photographing parameters, and information concerning, for example, an analysis result of an acquired image.

Step S3 shows a standby state of photographing operation. If the photographing operation is not performed, the control unit 11 returns processing to step S1. If the photographing operation is performed, the control unit 11 shifts to step S4. The recording control unit 11d of the control unit 11 records the picked-up image in the region 15a of the recording unit 15. The metadata creating unit 11b creates the table format section in extended metadata and records the table format section in the region 15a. Considering security of information obtained in control at an instance of photographing by calculating and recording a hash value (in FIG. 3, state operation recording) is important processing because this is basic information of a subsequent image evaluation (step S4).

In step S2, the operation and image analysis unit 11a may automatically acquire an evaluation (a primary evaluation) concerning the picked-up image. For example, the operation and image analysis unit 11a may analyze a focus state of the picked-up image and acquire an analysis result as information concerning the primary evaluation. In this case, the metadata creating unit 11b describes, in the evaluation section, the information concerning the primary evaluation automatically acquired by the operation and image analysis unit 11a. The photographer may perform the primary evaluation on the picked-up image by operating the operation section 13. In this case, the metadata creating unit 11b describes, in the evaluation section, information concerning the primary evaluation based on user operation. Note that the metadata creating unit 11b describes information concerning the photographer in the user section. Note that the primary evaluation may indicate, with relatively simple classification or the like, a state of the recorded picked-up image. For example, when an evaluation is performed about a focus, information concerning a classification result of two kinds of good and bad, a five-stage evaluation, or the like may be described as the primary evaluation.

In the present embodiment, in the table format section, a control word standardized to a certain degree, so to speak, a set phrase is selected and described according to necessity. Therefore, the table format section is excellent in retrievability and uniqueness at a time of retrieval or analysis. As a result, the user can grasp, with relatively simple operation, a state (an environment and photographing parameters) at picked-up image acquisition time recorded by the relatively simple classification or the like.

The state at the picked-up image acquisition time is considered to be information concerning a state at an instance or a transitory state. In a sense different from information concerning a comment of the like to be rewritten afterward, the state at the picked-up image acquisition time is often a type that cannot be determined again if correct data disappears. The state at the picked-up image acquisition time needs to be packaged together with the image data to consider security. Therefore, there is meaning in storing such data in the first region and hashed together with the state at the picked-up image acquisition time. This is because, if the state at the picked-up image acquisition time changes, it is likely that a ground for a later analysis or the like is lost. As explained above, there is means for, after additionally writing a comment in the second region, hashing the second region together with the first region. It is possible to sequentially check at such timing whether data during photographing does not change.

In other words, the present invention is considered to make it possible to guard, in multiple layers, the first region obtained for the instance during the photographing and track at which timing there is a change irrespective of whether the change is deliberate or not.

The present invention is considered to be an invention of an information processing apparatus including a state operation unit that records a hash value of the first region in the second region (a dedicated recording region may be separately provided) and applies security processing for recording a hash value obtained by combining data in the second region and the first region.

Since the hash value can also be considered metadata, the present invention can also be considered an invention of a metadata creation method or apparatus recording a hash value of the first region in the second region as the metadata and recording a hash value of the second region after the hash value recording, in a metadata creation method or apparatus characterized in creating first metadata in which information concerning the picked-up image is represented with structured data using a predetermined control word in order to record the first metadata in the first region in the image file, and in creating second metadata concerning the picked-up image with unstructured data in order to record the second metadata in the second region in the image file designated by information recorded as an item of the structured data. Consequently, it is possible to determine that, if the hash of the second region is good, there is no problem as a whole. The hash value of the second region after the hash value recording may be recorded in a structured-data recording unit different from the first region as metadata.

The security processing unit 11e packages the recorded image data and the data of the table format section, carries out a hash operation (a state operation), and records an operation result (a hash value) in the recording unit 15. Consequently, it is possible to guarantee that various kinds of information including the primary evaluation of the picked-up image and the table format section are not tampered with.

In next step S5, the control unit 11 determines whether additional writing (a secondary evaluation) is present. The secondary evaluation is performed by, for example, the user. The control unit 11 may display a message for checking presence or absence of the additional writing on the display unit 14 and determine presence or absence of the secondary evaluation according to user operation. When the additional writing is absent, the control unit 11 returns the processing to step S1. When the additional writing is present, the control unit 11 shifts the processing to step S6.

In step S6, the metadata creating unit 11b additionally writes the reevaluation (the secondary evaluation) based on the user operation in a first extended evaluation section of the extension section. The reevaluation can be described in, for example, a text format. The user can freely input the reevaluation and perform a detailed evaluation. For example, even when a focus of the picked-up image is described only as “good” by the simple classification in the primary evaluation, detailed information such as states of a focus of a main part of the image and a focus of other portions can be described in the secondary evaluation. For example, even when “good” is described in the primary evaluation, “not good” can be described and a reason for “not good” can be described in the secondary evaluation.

The secondary evaluation can be described in a free format as long as the secondary evaluation is described according to predetermined syntax information. Therefore, the secondary evaluation is inferior in uniqueness at retrieval and interpretation time and an extent of systems that can be treated and, on the other hand, has a high degree of freedom. Detailed content can be described in the secondary evaluation. It is possible to, according to necessity, observe in detail and describe, for a long time, not information at an instance of photographing but various events involved in the photographing and information captured in a photographed image. When an image needs to be corrected, if it is explained in the secondary evaluation to that effect, it is also possible to take into account the explanation in a later evaluation.

The metadata creating unit 11b describes, in the extension section, link information indicating a position on the image file or a position on the memory of next additional writing (a tertiary evaluation). The security processing unit 11e packages the package of the image data and the table format section and the extension section, carries out the hash operation (the state operation), and records an operation result (a hash value) in the recording unit 15. Even in this case, it is guaranteed that respective kinds of information including the primary evaluation of the picked-up image and the table format section is not tampered with. It is also guaranteed that the secondary evaluation is not tampered with. If the secondary evaluation is not tampered with, it is possible to conveniently determine that the respective kinds of information including the primary evaluation of the picked-up image and the table format section are not tampered with either. Since evidence indicating what is viewed to perform the secondary evaluation remains, reliability of the evaluation result is improved. It is easy to arrange information about how the image is treated.

In step S7, the control unit 11 determines whether reproduction is instructed. When reproduction is not instructed, the control unit 11 returns the processing to step S1. When reproduction is instructed, the control unit 11 performs the reproduction in step S8. The control unit 11 reads out the image data recorded in the recording unit 15, gives the image data to the display unit 14, and causes the display unit 14 to display the image data on the display screen. The control unit 11 reads out, according to necessity, information of the table format section and, if present, information of the extension section and displays the information on the display screen of the display unit 14 with a text or the like recognizable by the user. The control unit 11 also displays a message for checking presence or absence of further additional writing. If the additional writing is the tertiary evaluation, it may be determined at this timing whether data recorded to that point is not tampered with. This is because, when data correction of an image or the like due to an unknown reason is performed, it is unknown whether a subsequent evaluation has meaning.

In next step S9, the control unit 11 checks presence or absence of additional writing. When additional writing is absent, the control unit 11 shifts the processing to step S11. When additional writing is present, the control unit 11 shifts the processing to step S10. Step S10 is the same processing as step S6. The control unit 11 performs input processing for the additional writing and generation of link information and a state operation for next additional writing. The metadata creating unit 11b and the security processing unit 11e record updated information in the recording unit 15. If the tertiary evaluation and data preceding the tertiary evaluation are hashed, it is seen that there is no problem in a series of photographing and a flow and a history of evaluations as a whole if there is an abnormality in a hash value of the tertiary evaluation. If a temper is not determined by viewing the hash value including the tertiary evaluation, it is possible to conveniently determine that the respective kinds of information including the primary evaluation of the picked-up image and the table format section are not tampered with either.

In step S1, the control unit 11 determines whether transmission operation is performed. When the transmission operation is not performed, the control unit 11 returns the processing to step S1. When the transmission operation is performed, the control unit 11 shifts the processing to step S12 and transmits the recorded information.

Note that an information processing apparatus having the same function as the information processing apparatus shown in FIG. 1 is capable of performing additional writing about an evaluation, addition of link information, hashing, and the like on the transmitted image file by the same processing as step S10 explained above.

In the above explanation, an example is explained in which, in the secondary evaluation and the subsequent evaluations to be additionally written, user information is not additionally written assuming that the same user as the user who inputs the primary evaluation inputs the evaluations. However, when an evaluating user is different, user information is described in the extension section.

In the above explanation, the secondary evaluation and the subsequent evaluations to be additionally written are also explained as being inputted by the user. However, evaluation information may be generated by AI processing. In this case, the generation of the evaluation information by the AI is described in the extension section. However, whether AI or a person performs the evaluation or whether the person is an expert or the like is sometimes considered extremely important in a specific market or technical field and, therefore, may be able to be structured and described in the first region. However, it is difficult to structure identifications about where and who a person is in the first region because the identifications have uncountable possibilities. The identifications only have to be described in detail in the second region.

To make it easy to check an additional writer, for example, information concerning a time period of additional writing may be described in the table format section and the extension section for each additional writing.

### (Security and Link Information)

In the example shown in FIG. 3, to secure security, the table format section including the link information is packaged and hashed. Thereafter, every time the extension information is additionally written, a package to that point and an additionally written portion are packaged and hashed. Accordingly, a method of describing link information for next additional writing in advance before additional writing is adopted. However, this method is not the only method. For example, a portion excluding the link information may be packaged and hashed. Consequently, even when the link information for the additional writing is described for each additional writing, it is possible to secure security.

As explained above, in the present embodiment, the image file is configured using the extended metadata including the table format section by the structured data and the extension section by the unstructured data. The link information for the access to the extension section is described in the table format section. For example, the evaluation by the relatively simple classification is described in the table format section. The detailed evaluation is described in the extension section. Consequently, it is possible to relatively easily retrieve an image in the image file using the table format section. It is possible to easily acquire a detailed evaluation with the link information of the table format section. It is possible to facilitate utilization of an image.

As explained above, the image data and the table format section are packaged and hashed. Thereafter, an extension section to be additionally written and a package to that point are packaged and hashed. It is possible to prevent tampering of data immediately after photographing. It is possible to prevent tampering of evaluations at respective stages of additional writing.

### Second Embodiment

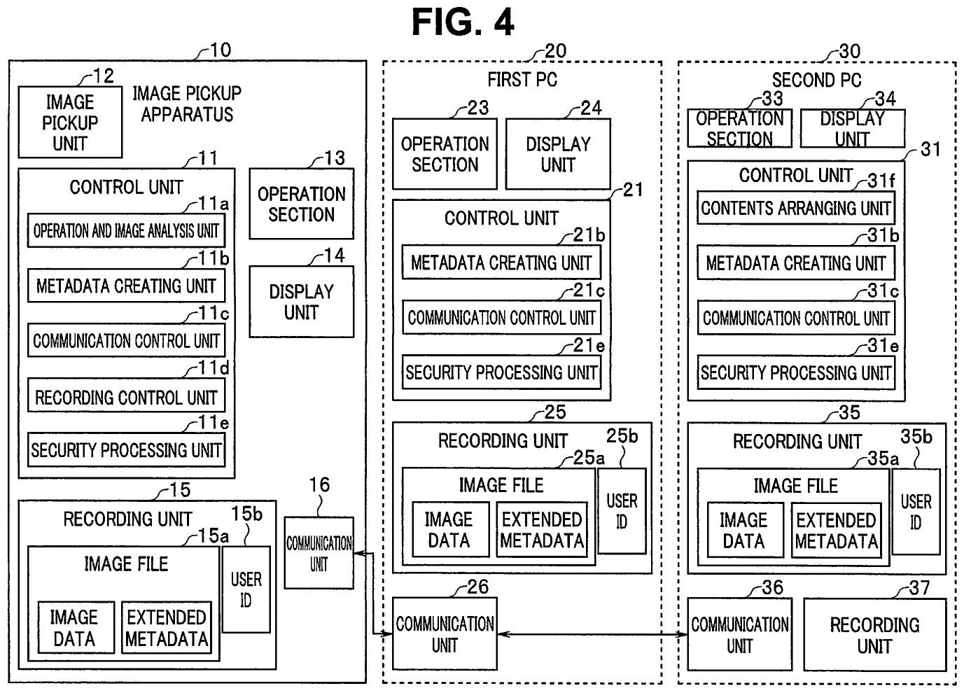

FIG. 4 is a block diagram showing a second embodiment of the present invention. In FIG. 4, the same components as the components shown in FIG. 1 are denoted by the same reference numerals and signs and explanation of the components is omitted. An example shown in FIG. 4 is an example in which three information processing apparatuses, that is, the image pickup apparatus 10, a first computer (first PC) 20, and a second computer (second PC) 30 are used. However, the second embodiment may be configured by one information processing apparatus. The present embodiment indicates an example in which information processing apparatuses operated by different users generate extended metadata of the same image file in cooperation with one another. For example, in the example shown in FIG. 4, image data and a table format section in extended metadata are created by the image pickup apparatus 10, a first extension section is created by the first PC 20, and a second extension section is created by the second PC 30. In other words, the present embodiment indicates that, even if an image is acquired, a process does not end and various post processes are used in cooperation and further indicates that the respective information processing apparatuses are involved in an image in roles of the respective information processing apparatuses.

In FIG. 4, an operation section 23, a display unit 24, a recording unit 25, and a communication unit 16 of the first PC 20 respectively have the same functions as the functions of the operation section 13, the display unit 14, the recording unit 15, and the communication unit 16 of the image pickup apparatus 10. An operation section 33, a display unit 34, a recording unit 35, and a communication unit 36 of the second PC 30 respectively have the same functions as the functions of the operation section 13, the display unit 14, the recording unit 15, and the communication unit 16 of the image pickup apparatus 10.

The first PC 20 includes a control unit 21 that controls the entire first PC 20. The control unit 21 may be configured by a processor using a CPU or an FPGA, may operate according to a program stored in a not-shown memory and control respective units, or may realize a part or all of functions with a hardware electronic circuit.

The second PC 30 includes a control unit 31 that controls the entire first PC 20. The control unit 31 may be configured by a processor using a CPU or an FPGA, may operate according to a program stored in a not-shown memory and control respective units, or may realize a part or all of functions with a hardware electronic circuit.

In FIG. 4, the image pickup apparatus 10, the first PC 20, and the second PC 30 have the same function concerning creation of an image file. In other words, the control unit 21 of the first PC 20 includes a metadata creating unit 21b, a communication control unit 21c, and a security processing unit 21e. These units respectively have the same functions as the functions of the metadata creating unit 11b, the communication control unit 11c, and the security processing unit 11e of the image pickup apparatus 10.

The control unit 31 of the second PC 30 includes a metadata creating unit 31b, a communication control unit 31c, and a security processing unit 31e. These units respectively have the same functions as the functions of the metadata creating unit 11b, the communication control unit 11c, and the security processing unit 11e of the image pickup apparatus 10.

The control unit 31 includes a contents arranging unit 31f. The contents arranging unit 31f arranges image files created by the image pickup apparatus 10, the first PC 20, and the second PC 30 and records the image files in the recording unit 35.

The image pickup apparatus 10, the first PC 20, and the second PC 30 are configured to be communicable with one another by communication units 16, 26, and 36 via a local network or via the Internet.

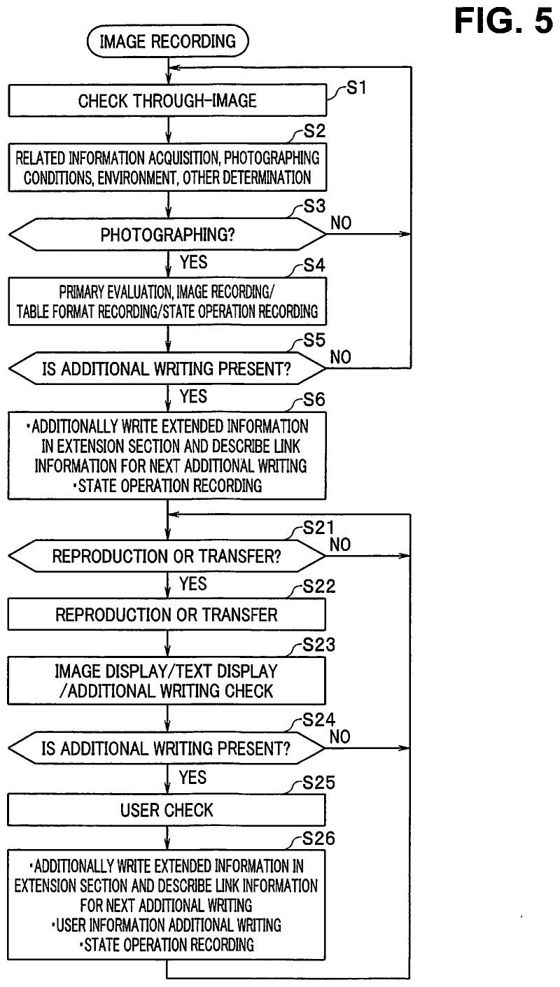

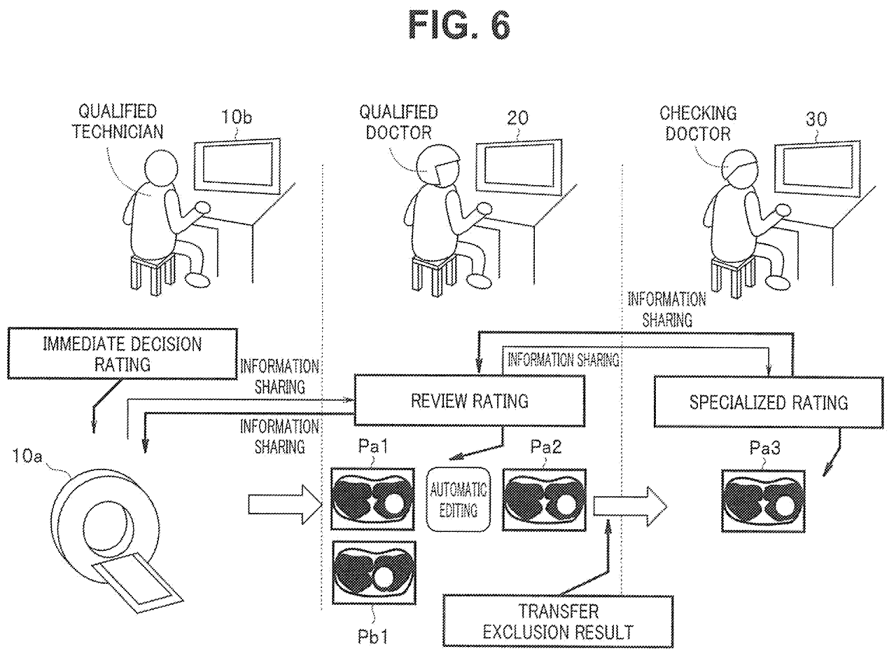

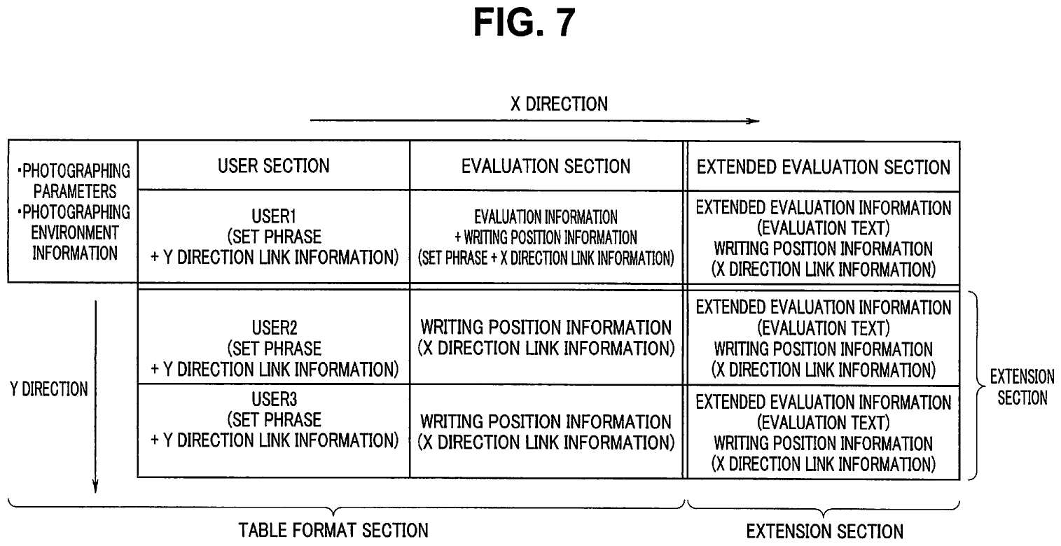

Subsequently, operation in the embodiment configured as explained above is explained with reference to FIGS. 5 to 7. FIG. 5 is a flowchart showing an operation flow adopted in the second embodiment. FIG. 6 is an explanatory diagram showing an example of a method of use assumed in the second embodiment. FIG. 7 is an explanatory diagram showing extended metadata generated in the second embodiment. In FIG. 5, the same procedures as the procedures shown in FIG. 3 are denoted by the same signs and explanation of the processes is omitted.

An example of use shown in FIG. 6 is application to generation of an image file in a medical site and indicates an example in which the image pickup apparatus 10 is configured to be divided into a computer tomographic photographing apparatus (a CT scan apparatus) 10a and a control apparatus 10b. The CT scan apparatus 10a and the control apparatus 10b are capable of communicating with each other. The CT scan apparatus 10a is controlled by the control apparatus 10b to perform tomographic photographing of a human body and output a three-dimensional image (a picked-up image) to the control apparatus 10b via a not-shown transmission line. A user of the control apparatus 10b is a qualified technician who operates the CT scan apparatus 10a. A user of the first PC 20 is a qualified doctor. A user of the second PC 30 is a doctor who checks diagnosis such as a specialized doctor.

Note that, in FIG. 6, an example is shown in which the image pickup apparatus 10 is configured by the CT scan apparatus 10a and the control apparatus 10b. However, the image pickup apparatus 10 can be configured by a combination of various apparatuses having an image pickup function and a control function. For example, the image pickup apparatus 10 can also be configured by a combination of a camera for consumer use and a smartphone.

Processing in steps S1 to S6 in FIG. 5 are the same as the processing in the steps in FIG. 3 and are carried out by the CT scan apparatus 10a and the control apparatus 10b configuring the image pickup apparatus 10. Processing in steps S21 to S26 in FIG. 5 is likely to be carried by in all of the image pickup apparatus 10, the first PC 20, and the second PC 30.

For example, in a large intestine CT scan test or the like, image reading (primary image reading) of a picked-up three-dimensional image (a picked-up image) is performed by the qualified technician who operates the CT scan apparatus 10a. The qualified technician causes a picked-up image of the CT scan apparatus 10a to be displayed on a display screen of the control apparatus 10b and performs image reading of the picked-up image and, about an image determined as having possibility of presence of a lesioned part as a result of the image reading, performs rating (immediate decision rating) of the possibility.

In other words, according to the operation of the qualified technician, the control unit 11 in the control apparatus 10b determines that additional writing is present (step S5) and, in next step S6, describes a result of the immediate decision rating in an evaluation section of the table format section.

In general, subsequent to the primary image reading by the qualified technician, secondary image reading by the qualified doctor, tertiary image reading by the specialized doctor, and the like are performed. In step S21, the control units 11, 21, and 31 of the image pickup apparatus 10, the first PC 20, and the second PC 30 determine whether an instruction for reproduction or transfer is generated. After the primary image reading, the qualified technician transfers the generated image file to the qualified doctor according to necessity.

The communication control unit 11c in the control apparatus 10b transmits, to the first PC 20, an image file including an image determined as having possibility of presence of a lesioned part by the immediate decision rating of the qualified technician (step S22). In FIG. 6, an image file Pa1 indicates an image file including an image in which presence of a lesioned part is indicated among a plurality of images acquired by the CT scan apparatus 10a. An image file Pb1 indicates an image file including an image in which absence of a lesioned part is determined. For example, the qualified technician performs operation for transmitting the image file Pa1 to the first PC 20 and also transmits the image file Pb1 to the first PC 20 as an exclusion result.

The communication unit 26 of the first PC 20 receives the image file transmitted by the communication unit 16. The control unit 21 of the first PC 20 reproduces the received image file, displays a three-dimensional image, and displays information of the table format section and the extension section (step S23). Consequently, a result of the primary image reading by the qualified technician is displayed based on the information of the evaluation section and the extension section. Display for checking presence or absence of additional writing is also performed on the display screen.

The qualified doctor who operates the first PC 20 performs the secondary image reading referring to the result of the primary image reading by the qualified technician. In other words, the qualified doctor obtains, based on an analysis result of the qualified technician, an analysis result (review rating) concerning diagnosis of a lesion or the like.

In next step S24, the control unit 21 of the first PC 20 checks presence or absence of additional writing. When additional writing is absent, the control unit 21 returns the processing to step S1. When additional writing is present, the control unit 21 shifts the processing to step S25.

In the present embodiment, in step S25, the control unit 21 of the first PC 20 acquires information concerning a user performing additional writing. Subsequently, in step S26, the metadata creating unit 21b of the control unit 21 performs additional writing in the extension section. Step S26 is the same processing as step S6. Input processing for additional writing, generation of link information for next additional writing, and a state operation are performed. Further, in the present embodiment, user information for specifying the user performing the additional writing is additionally written in the extension section. The metadata creating unit 11b and the security processing unit 11e record updated information in the recording unit 25 of the first PC 20. In this way, additional writing is performed in the image file Pa1 and an image file Pa2 is obtained.

When the image is transferred and becomes accessible in different places in this way, it is also conceivable that different users write separate evaluations depending on a situation. However, as in this application, it is seen which user views and additionally writes which evaluation. Therefore, an effect is exerted in terms of arrangement of information.

After the secondary image reading, the qualified doctor transfers the generated image file Pa2 to the specialized doctor or the qualified technician according to necessity. In this way, information sharing is performed between the qualified doctor and the qualified technician.

The communication unit 36 of the second PC 30 receives the image file Pa2 transmitted by the communication unit 26. The control unit 31 of the second PC 30 reproduces the received image file Pa2, displays a three-dimensional image, and displays information of the table format section and the extension section (step S23) Consequently, a result of the secondary image reading by the qualified technician is displayed based on the information of the evaluation section and the extension section. Display for checking presence or absence of additional writing is also performed on the display screen.

The specialized doctor who operates the second PC 30 performs the tertiary image reading referring to the result of the secondary image reading by the qualified doctor. In other words, the specialized doctor obtains, based on an analysis result of the qualified doctor, an analysis result (a specialized rating) concerning diagnosis of a lesion or the like.

In next step S24, the control unit 31 of the second PC 30 checks presence or absence of additional writing. When additional writing is absent, the control unit 31 returns the processing to step S1. When additional writing is present, the control unit 31 shifts the processing to step S25. In this case, in step S25, information indicating that a user performing additional writing is the specialized doctor is acquired. Subsequently, in step S26, the metadata creating unit 31b of the control unit 31 performs additional writing in the extension section. In this way, input processing for additional writing, addition of the user performing additional writing, generation of link information for next additional writing, and a state operation are performed and an image file Pa3 is created.

As explained above, ratings are carried out one after another by the qualified technician, the qualified doctor, and the specialized doctor on the image acquired by the CT scan apparatus 10a. Results of all the ratings are described in one image file Pa3.

FIG. 7 shows an example of extended metadata in this case.

The extended metadata shown in FIG. 7 is different from the extended metadata shown in FIG. 2 in that the extended metadata is extended also concerning the user. A user 1 shown in FIG. 7 corresponds to the qualified technician. Link information (X direction link information) for accessing information of an extended evaluation section added by the user 1 is described in an evaluation section corresponding to the user 1. In an extension section, link information (X direction link information) for accessing an extension section to be additionally written next is described. Note that the X direction link information is the same type of information as the link information shown in FIG. 2.

In the present embodiment, for extension of users, link information (Y direction link information) for accessing information concerning a user to be extended next is described in a user section. The Y direction link information is information for specifying a position on an image file or a position on a memory of information concerning a next user.

The Y direction link information may be a method of describing, in a structured first region, information indicating that a user is added every time users (an aspect of evaluators is considered important) increase to two and three and information indicating how many evaluators are present. This method only has to use a method of writing, in a form delimited by commas, in the first region, only alphanumerical characters and signs like an ASCII code to make it possible to freely describe, in a text, (describe, in an unstructured or semi-structured form) data of evaluation results of respective users in an extended region present in a storage region represented by extended link information represented by the respective alphanumerical characters and signs. In this case, simply by checking the first region, it is possible to easily check how many people performed evaluations. Simple user information indicating an evaluation result by an inference model, an evaluation result by a human, or an evaluation result by an expert may be described in the first region. Only extended link information of a user 2 may be described in the first region and extended link information concerning who a user 3 is and what kind of evaluation the user 3 performed may be additionally written in a region extended for the user 2.

Note that an expression “evaluation of an image” is used above. However, in many cases, an evaluation of a target object represented by an image is often more important. In other words, in some case, the image is merely an evidence photograph and an evaluation result is actually more important.

As explained above, since there are fields and areas where it should be strictly managed who evaluated such an image, in FIG. 7, people who performed an evaluation and opinions of the people are clearly classified and distinguished. For example, in an area where only an opinion of an expert is necessary, opinions of the other people, writing information of a machine, and the like may be neglected. There is an advantage that time for converting text information or the like in an unstructured (or semi-structured) state into a sentence, time for correctly interpreting the text information or the like without misunderstanding, and the like can be saved and requested correctness can be pursued. If the user data is structured data, only specific classification can be performed. However, when an image is shared on the Internet and various users evaluate the image in cooperation, a request can be satisfied by only unstructured data that can be described in a text to a certain degree. The respective users copy and evaluate the image at a stage when the image is shared on the Internet in some cases. Such history information of the image can be desirably described by unstructured data in the extended evaluation section because a degree of freedom is higher. It is difficult to treat, as structured data, who requested the evaluation, when and how the image was downloaded, in which viewpoint the image was evaluated, and the like.

In other words, according to the above, there can be provided a recording control method capable of recording image data and information obtained by evaluating an image of the image data in association with each other, the recording control method including: a recording control step in a first recording region for recording a plurality of evaluation entities that evaluate the image and data in a table format indicating presence or absence of an evaluation result of each of the plurality of evaluation entities; and a recording control step in a second recording region for recording, as unstructured data, detailed information of the plurality of evaluation entities and an evaluation result of the plurality of evaluation entities. As explained above, the same information processing apparatus performs these steps in some case and different apparatuses perform these steps in cooperation in other cases. When an evaluation of information present in the first recording region is advanced with reference to different evaluators, the evaluation increases in time series. However, since a first region, previous evaluation results, and information concerning the evaluators are hashed together every time the evaluation increases, it is possible to check overall consistency every time, increase opportunities for finding tampering, a change, or the like, and, when tampering, a change, or the like is found, immediately detect a step of occurrence of the trouble or an intact region, and quickly determine a step of determining reliability of data and creating metadata again.

Note that, about the user 2 and the subsequent users, only link information to the extended evaluation section of the respective users is described in the evaluation section. However, classification information of a result obtained by relatively simple classification may be described by a table format.

As explained above, by metadata creation, unstructured data indicating information concerning the picked-up image (for example, who evaluated the picked-up image and how the person (or a computer, a robot, or the like) evaluated the picked-up image) is obtained in each of a plurality of second regions in which the extended region (the second region) is extended to be dividable in plurality. The second region is extended to the plurality of second regions and information concerning the extension of the second region is additionally written in the table format section (the first region) in some cases and is additionally written in the second region in other cases. If the information is additionally written in the table format section, this portion functions as a table of content or an index. It is possible to access necessary additionally written information without performing syntax interpretation. If there is a system or an environment that is good at syntax interpretation, a method of tracing the second region may be adopted. A method only has to be selected according to an assumed system or environment.

As explained above, the extended metadata shown in FIG. 7 can not only describe an extended evaluation by the same user but also describe an extended evaluation by different users. According to such a method of arrangement, it is easy to manage the users and evaluations of the users as a pair. Means for, for example, collectively hash the users and the evaluations are utilized. It is meaningful to integrate the users and the evaluations. Collective management makes it easier to determine presence or absence of tampering.

Note that FIG. 6 shows the example of the application to the medical field. However, the present embodiment can be effectively used in a scene in which different users generate one image file while sequentially additionally writing evaluations. For example, the present embodiment can be used when a studio photograph is created.

For example, it is assumed that a cameraman performs photographing using the image pickup apparatus 10 and, thereafter, performs, for example, a five-stage evaluation about superiority and inferiority of a photograph and describes a result of the evaluation in the evaluation section of the table format section. An image file recorded by the image pickup apparatus 10 is transferred to the first PC 20 and a secondary evaluation is performed by an assistant. The assistant sometimes performs evaluation for excluding an image determined as having a defective angle of view, focus, or the like from, for example, images determined as satisfactory by a primary evaluation by the cameraman. The secondary evaluation is described in the extension section in the image file. Further, the image file in which the primary evaluation and the secondary evaluation are additionally written is transferred to a requester of the studio photograph. A tertiary evaluation is performed by the second PC 30 of the requester. In this way, with the generated image file, information of the primary evaluation, the secondary evaluation, and the tertiary evaluation can be checked. Information about who performed these evaluations can also be checked. In such evaluations and the like, words of a local rule are frequently used. The evaluations can be utilized in more scenes if the evaluations can be treated in data other than the structured data in the extended region.

As explained above, in the present embodiment, the same effects as the effects in the first embodiment are obtained and there is an advantage that the extension of users can be easily performed.

Note that, in the explanation in the respective embodiments of the present invention, as the device for photographing, the normal camera, the medical camera, and the like is used. However, any image pickup device may be adopted if the image pickup device can acquire a picked-up image. If a setting place may be any place, a device for photographing may be a lens-type camera, a digital single-lens reflex camera, or a compact digital camera, may be a camera for a moving image such as a video camera or a movie camera, or may be a camera incorporated in a portable information terminal (PDA: personal digital assistant) such as a cellular phone or a smartphone. The device may be an industrial or medical optical device such as an endoscope or a microscope or may be a monitoring camera, a vehicle-mounted camera, or a stationary camera, for example, a camera attached to a television receiver, a personal computer, or the like. Naturally, it goes without saying that the idea of this application can be applied and used when various contents data such as a moving image and voice are managed. The photographed image may be rewritten as acquired contents.

In the above explanation, the semi-structured data is included in the unstructured data. However, the semi-structured data may not be always used. This is because the semi-structured data has an image of assuming a specific standard system and some users do not want to conform to the specific standard system.

In this case, it is also possible to adopt an application for, during metadata creation for creating metadata concerning a picked-up image, creating, in the first region in the image file, information concerning the picked-up image as structured data using a predetermined control word, and creating, in the second region extended by information recorded as items of the structured data in the image file, the information concerning the picked-up image with unstructured data. With this method, metadata using the unstructured data having a more degree of freedom can be described making use of uniqueness of interpretation of the control word. Presence or absence and a recording region of extended information and basic information (a basic evaluation such as rating) recorded in the extended information can be briefly described by the structured data. It is possible to, while eliminating fluctuation in interpretation, place information supplementing the interpretation in the extension section.

When a hash value of the first region is recorded in the second region, since the second region is the unstructured data, storage of the hash value is easily concealed. Since the hash value is easily set to a simple alphanumerical character that is relatively easily treated, the hash value of the second region may be easily searched in a structured portion or may be stored in another region.

Further, the portion described as the section or the unit in the embodiments may be configured as a dedicated circuit or configured by combining a plurality of general-purpose circuits or, according to necessity, may be configured by combining processors such as a microprocessor and a CPU or sequencers that perform operation according to software programmed in advance. Design for performing, in an external apparatus, a part or all of controls of the portion is also possible. In this case, a wired or wireless communication circuit is interposed. An embodiment in which an external device such as a server or a personal computer performs the characteristic processing and supplementary processing of this application is also assumed. In other words, this application also covers a case in which a plurality of devices establish the characteristics of the present invention in cooperation. For communication at this time, Bluetooth (registered trademark), Wi-Fi (registered trademark), a telephone line, or the like is used. The communication at this time may be performed by USB or the like. The dedicated circuit, the general-purpose circuit, and the control unit may be integrated and configured as an ASIC.

The present invention is not limited to the respective embodiments per se. In an implementation stage, the constituent elements can be modified and embodied in a range not departing from the gist of the present invention. Various inventions can be formed by appropriate combinations of a plurality of constituent elements disclosed in the respective embodiments. For example, several constituent elements among all the constituent elements explained in the embodiments may be deleted. Further, the constituent elements in different embodiments may be combined as appropriate.

Note that, even if the operation flows described in the claims, the specification, and the drawings are explained using “first”, “next”, and the like for convenience, this does not mean that it is essential to implement the operation flows in this order. It goes without saying that portions not affecting the essence of the invention in the respective steps configuring the operation flows can be omitted as appropriate.

Among the techniques explained herein, most of the controls and the functions mainly explained in the flowcharts can be set by a program. The controls and the functions explained above can be realized by a computer reading and executing the program. The entire program or a part of the program can be recorded or stored as a computer program product in a portable medium such as a flexible disk, a CD-ROM, or a nonvolatile memory or a recording medium such as a hard disk or a volatile memory. The program can be distributed or provided during product shipment or via a portable medium or a communication line. A user can easily realize the information processing apparatus in the present embodiments by downloading the program via a communication network and installing the program in a computer or installing the program in the computer from a recording medium.

What is claimed is:

1. An information processing apparatus comprising a processor, wherein the processor:
acquires a picked-up image;
creates metadata concerning the picked-up image;
records an image file including the picked-up image and the metadata; and
creates, as the metadata, information concerning the picked-up image with a table format in a first region in the image file and creates information concerning the picked-up image with unstructured data in at least one second region extended by the information recorded by the table format in the image file.

2. The information processing apparatus according to claim 1, wherein the processor creates, in the first region, a registered control word with the table format.

3. The information processing apparatus according to claim 1, wherein the processor records a hash value of the first region in the at least one second region and records a hash value of the at least one second region after the hash value recording to thereby perform security processing.

4. The information processing apparatus according to claim 1, wherein the processor extends the at least one second region to the second region in plurality and creates information concerning the picked-up image in the extended second region in plurality with the unstructured data.

5. The information processing apparatus according to claim 4, wherein the processor extends the at least one second region to the second region in plurality and additionally writes information concerning the extended second region in plurality in a table format section.

6. The information processing apparatus according to claim 4, wherein at least one second region among the second region in plurality is a region extended by information recorded by the unstructured data.

7. The information processing apparatus according to claim 1, wherein
the processor creates, in at least one third region extended by the information recorded by the table format in the image file, the information concerning the picked-up image with the table format, and creates, in at least one fourth region extended by the information recorded in the at least one third region by the table format, the information concerning the picked-up image with the unstructured data.

8. The information processing apparatus according to claim 7, wherein the processor creates, in the third region in plurality, the information concerning the picked-up image with the table format and creates, in the fourth region in plurality, the information concerning the picked-up image with the unstructured data.

9. The information processing apparatus according to claim 1, wherein the processor describes, in the first region, a primary evaluation for the picked-up image and describes, in the at least one second region, a secondary evaluation for the picked-up image.

10. The information processing apparatus according to claim 1, wherein the processor creates a primary evaluation based on an acquired picked-up image.

11. The information processing apparatus according to claim 8, wherein the processor describes information concerning different users in the first region and the at least one third region.

12. The information processing apparatus according to claim 1, further comprising a sensor that picks up an image of an object and obtains the picked-up image, wherein
the processor creates, during the image pickup of the sensor, in the first region, the information concerning the picked-up image with the table format, records the image file in which the first region is created, and reads out the image file in which the first region is created and creates, in the at least one second region, the information concerning the picked-up image with the unstructured data.

13. The information processing apparatus according to claim 3, wherein the processor packages the first region and the at least one second region and performs the security processing.

14. The information processing apparatus according to claim 3, wherein the processor creates, in the second region in plurality, the information concerning the picked-up image with the unstructured data, packages the first region and the at least one second region and performs the security processing, and packages the first region and all of the extended second region in plurality and performs the security processing every time the at least one second region is extended.

15. An information processing system comprising a plurality of information processing apparatuses each including a processor, wherein
the processor:
acquires a picked-up image;
creates metadata concerning the picked-up image;
records an image file including the picked-up image and the metadata; and
creates, as the metadata, information concerning the picked-up image with a table format in a first region in the image file and creates the information concerning the picked-up image with unstructured data in at least one second region extended by the information recorded by the table format in the image file, and
the processor in a first information processing apparatus among the plurality of information processing apparatuses creates the information concerning the picked-up image with the table format in the first region and the processor in a second information processing apparatus among the plurality of information processing apparatuses creates the information concerning the picked-up image with the unstructured data in the at least one second region.

16. An information processing system comprising a plurality of information processing apparatuses each including a processor, wherein
the processor:
acquires a picked-up image;
creates metadata concerning the picked-up image;
records an image file including the picked-up image and the metadata; and
creates, as the metadata, information concerning the picked-up image with a table format in a first region in the image file and creates the information concerning the picked-up image with unstructured data in at least one second region extended by the information recorded by the table format in the image file, and
the processor in a first information processing apparatus among the plurality of information processing apparatuses creates the information concerning the picked-up image with the table format in the first region and the processor in a second information processing apparatus among the plurality of information processing apparatuses creates the information concerning the picked-up image with the table format in the at least one second region.

17. An information processing method comprising:
acquiring a picked-up image;
creating, as metadata concerning the picked-up image, information concerning the picked-up image with a table format in a first region in an image file and creating the information concerning the picked-up image with unstructured data in at least one second region extended by the information recorded by the table format in the image file; and
recording the image file including the picked-up image and the metadata.

18. A non-transitory computer-readable recording medium recording an information processing program, the program being for causing a computer to execute a procedure for:
acquiring a picked-up image;
creating, as metadata concerning the picked-up image, information concerning the picked-up image with a table format in a first region in an image file and creating the information concerning the picked-up image with unstructured data in at least one second region extended by the information recorded by the table format in the image file; and
recording the image file including the picked-up image and the metadata.

19. An information processing apparatus comprising a processor, wherein
the processor:
acquires a picked-up image;
creates metadata concerning the picked-up image;
records an image file including the picked-up image and the metadata; and
creates, as the metadata and in a first region in the image file, information concerning the picked-up image in a table format by predetermined items as data for each of the items, and creates, in at least one second region extended by the information recorded by the table format in the image file, the information concerning the picked-up image with semi-structured data, unstructured data, or structured data by items other than the predetermined items.

20. A metadata creation method comprising:
in order to record first metadata among metadata for an image file including image data in a first region in the image file, creating, as the first metadata, information concerning a picked-up image as structured data, using a predetermined control word; and
in order to record second metadata among the metadata in at least one second region in the image file designated by information recorded as an item of the structured data, creating, as the second metadata, information concerning a hash value of the first region and the picked-up image as unstructured data.

21. The metadata creation method according to claim 20, wherein a hash value of the at least one second region after the hash value recording is recorded as the metadata in a structured data recording region different from the first region or in at least one third region in the image file designated by the information recorded as the item of the structured data.

22. An information processing method comprising:
acquiring an image;
creating, as metadata concerning the image, information concerning the image with a table format in a first region in an image file;
when recording the image file including the image and the metadata,
recording evaluation information of the image and a hash value of the first region in at least one second region extended by the information in the table format in the image file; and
recording, in a recording region different from the first region and the at least one second region, a hash value of data obtained by combining the data of the first region and the at least one second region.

23. A recording control method capable of recording image data and information concerning an evaluation of an image of the image data in association with each other, the recording control method comprising:
performing recording control on a first recording region for recording a plurality of evaluation entities that evaluate the image and data in a table format indicating presence or absence of an evaluation result of each of the plurality of evaluation entities; and
performing recording control on a second recording region for recording, as unstructured data, detailed information of the plurality of evaluation entities and the evaluation result of each of the plurality of evaluation entities.

24. A recording control method capable of recording image data and information concerning an evaluation of an image of the image data in association with each other, the recording control method comprising:
performing recording control on a first recording region for recording a plurality of evaluations obtained by evaluating the image and data in a table format indicating schematic information such as presence or absence of an evaluation result about the respective evaluations; and
performing recording control on a second recording region for recording, as unstructured data, detailed information of the plurality of evaluations.
